(19) United States
(12) Patent Application Publication
(10) Pub. No.: US 2005/0082470 A1
(43) Pub. Date: Apr. 21, 2005

(54) Method of utilizing "Holey" optical fibers for a passive, miniature liquid feed/collection system

(76) Inventors: Michael E. Dziekan, Naugatuck, CT (US); John B. Fenn, Richmond, VA (US); Joseph Bango, New Haven, CT (US)

Correspondence Address: CONN. ANALYTICAL CORP.;Attn: Joseph J. Bango, Jr., 696 AMITY ROAD, BETHANY, CT, 06524, US

(21) Appl. No.: 10/966,693

(22) Filed: Oct. 15, 2004

Related U.S. Application Data
(60) Provisional application No. 60/511,237, filed on Oct. 15, 2003.

(51) Int. Cl. H01J 49/00

(52) U.S. Cl. 250/281

(57) ABSTRACT

A method of utilizing a special type of optical fiber known as a “Holey fiber” for providing a glass, polymer or quartz “wick” for transporting liquids through capillary action from space propulsion to fluid collection. The “Holey fibers” are intended to replace the complicated hydrostatic liquid feed systems employed in analytical analysis. By utilizing these “Holey fibers”, a small, passive, self-regulated liquid feed system could be produced that is much smaller and more reliable due to the fact that there are no moving parts. The described invention also outlines the usage of “Holey fibers” in the role of forensic science, to collect and transport minute samples for subsequent laboratory analysis.

### CROSS REFERENCE TO RELATED APPLICATIONS

Provisional Application No. 60/511,237 was filed on 15 Oct. 2003

### BACKGROUND

1. Field of Invention

This invention relates in general to liquid feed systems, and specifically to applying the use of technology known as “Holey fibers” to effect an efficient means of passive, liquid feed transport in electrospray and related applications. In addition to a liquid feed system, the individual “Holey fibers” can also serve to perform collection of minute quantities of liquid for research or forensic use. Any electrospray application from mass spectrometry to colloidal space propulsion would benefit from this invention. Using a small optical fiber known as a “Holey fiber” produced with tiny capillary holes running throughout its length, a wicking or capillary action of fluid is obtained without the need for a hydrostatic feed pump. An additional benefit of this invention is the realization of small, sterile, disposable liquid sample containers—each containing their own passive hydrostatic feed system (a “Holey fiber” wick) for use in ElectroSpray Ionization Mass Spectrometers (ESI-MS). Each sample would be contained in its own individual, sterile, sample container to be automatically picked and placed by a robotic arm to be placed in the front end of a ESI-MS.

2. Background Description of Prior Art

Holey fibers are a relatively new class of optical waveguide that use an array of tiny hollow channels to guide light in a novel way. By using these “Holey fibers” as a wicking structure for electrospray and capillary based liquid feed applications, highly efficient needle sources could be produced to form a self-regulating feed system. The Idea of using a wick as a self-regulating capillary feed system is not a new one, as it was previously proposed by Dr. John B. Fenn to eliminate the necessity for a hydrostatic feed pump. In typical electrospray applications, liquid containing the analyte of interest is pumped through a metal needle that has an open end with a sharply pointed tip, such as the end of a syringe. The needle tip is attached to a high voltage supply. The end of the tip faces a counter-electrode plate held at ground potential (0 V) or at an opposite polarity potential to that of the needle. As the voltage is increased, the liquid becomes charged, and due to the pressure provided by the hydrostatic feed pump (syringe pump), the liquid starts pushing out of the needle tip. The liquid pushing out forms a shape described as the “Taylor cone”. At the very end of the cone, the droplets push away from one another into a fine spray, since they all contain the same electrical charge. The fine spray is called a plume or jet. Depending on the electric field used, the charges may be all positive or all negative. The droplets contain both solvent molecules as well as analyte molecules. As the solvent evaporates from the droplet, the droplet becomes smaller while the total charge on the droplet remains constant. When this happens, the concentration of charges increases per unit area of droplet surface increases. At a critical point, the charged droplet's surface tension can't hold together the high number of charges placed closer and closer together, and the droplet explodes into what is known as a Coulomb explosion, producing smaller, still highly charged droplets. This process repeats itself until eventually the tiny droplet containing the analyte and solvent molecules contains only a single analyte molecule, with all solvent molecules removed or evaporated. The remaining single analyte molecule is left as a multiply charged ion. Because the amount of liquid pulled away from the needle tip must be replaced at a like rate to keep the “Taylor cone” stable, a major component of any ESIMS is that of the hydrostatic feed system. The hydrostatic feed system must be capable of delivering a tiny controlled amount (typically microliter [10⁻⁶ L] to nanoliter [10⁻⁹ L] quantity) of liquid at a controlled rate to effect a stable Taylor cone. The described invention uses a “Holey fiber”, or more specifically, a glass optical fiber with small diameter holes running its length to effect a highly efficient wick feed system. The additional benefit of using an optical fiber is the fact that it is made from glass and is therefore a chemically inert material (excluding certain fluorine compounds). If a wick feed material is used that is made from a material that could react with a solvent, then erroneous results could be expected.

Another benefit of using a wick feed system was outlined by Dr. Fenn and Joseph J. Bango Jr., in the area of colloidal space propulsion, where a complicated hydrostatic feed pumping system is definitely not a desired method of fluid delivery. The wick feed system has the beauty of having no moving parts to break or wear out! By using a small glass fiber with tiny holes (Holey fiber), a very small diameter glass “wick” could be realized. The problem with having a tiny needle as a source with colloidal space propulsion is that of trying to fill the needle bore with a wicking material. A smaller needle source is preferable for space applications to limit the amount of fluid exposed to the vacuum of deep space. If a small enough needle could be used, a more volatile liquid could then be used to effect greater amounts of thrust. Currently, ionic liquids are being sought because of their near-zero vapor pressure. The problem with ionic liquids is that they are currently very costly and the molecular weights are not as high as more volatile chemicals. If a cheaper liquid is used that has a higher vapor pressure, then a very small needle bore is preferable, but getting a wicking structure into such a small needle bore is extremely difficult to manage, especially on a commercial basis. If the wicking structure is compressed too tightly inside the needle bore, then the capillary action will cease, therefore, a small needle with a wicking material is sought. The use of “Holey fibers” is an elegant solution to this dilemma. Any wicking material that is used would have to be characterized as to if it will interact with the liquid being used. If the liquid acts as a solvent for some fibrous wicking material, then the result is that the analyte would also contain the solvated wicking material. This would give erroneous results for the field of mass spectrometry, and would cause the usable lifetime to be shortened in space applications. The glass optical fiber “Holey fiber” does not have this difficulty.

### BRIEF DESCRIPTION OF THE DRAWINGS

FIG. 1 shows a Scanning Electron Microscope (SEM) picture or micrograph of a section of plant material showing the lengthwise holes located in the Xylem and Phloem structure.

FIG. 2 shows a Scanning Electron Microscope (SEM) picture or micrograph of the front face of a section of holey optical fiber. The micrograph shows the arrangement of the holes running through the length of the glass fiber.

FIG. 3 shows a Scanning Electron Microscope (SEM) picture or micrograph of a close up of the front face of a section of holey optical fiber. The micrograph shows an enlarged view of the holes running through the length of the glass fiber.

FIG. 4 shows a schematic representation of a method of delivering a coaxial flow of liquid, with one liquid of certain chemical properties in the larger holes encircling another liquid of differing characteristics through the smaller holes. This arrangement would allow a low volatility liquid to encapsulate or coat another liquid of higher volatility and enable the higher volatility liquid to be used in a high vacuum environment such as space.

FIG. 5 shows a three-dimensional drawing of a section of commercially available “Holey fiber” that was used for testing for use with electrosprays. The “Holey fiber” shown contains a standard 168 capillary holes, and would be more efficient at providing large quantity samples for an ESIMS.

FIG. 6 shows a three-dimensional drawing of a section of “Holey fiber” that would be used for minimum quantity samples for use with an ESIMS. The single small-bore capillary would waste very little of any available sample to be tested.

FIG. 7 shows a photograph of a laboratory test with a section of commercially available “Holey fiber”. The “Holey fiber” shown contains a standard 168 capillary holes, and was tested for its application into providing a regulated quantity of liquid for an electric colloidal thruster to be used for space missions.

FIG. 8 shows a graph of the resultant ElectroSpray current versus the applied ElectroSpray voltage for a “Holey fiber” containing 168 capillary holes, each having a diameter of 8.0 um (10⁻⁶ m). The fibers used are a long length of 4.13 inches and a half length of 2.10 inches.

FIG. 9 shows a drawing of a single “Holey fiber” that would be used to collect small liquid samples, or solvated “solid” samples for use in research or forensic work. The fibers used are coated with a firm support structure to prevent breakage of the glass “Holey fiber”.

FIG. 10 shows a drawing of an integral automated assay “Holey fiber” based integral passive hydrostatic feed system with electrospray needle. Each integral automated assay “Holey fiber” based integral passive hydrostatic feed system with electrospray needle would be placed into a vial containing a sample of liquid that would then be placed into the input stage of a mass spectrometer.

FIG. 11 shows a drawing of an integral automated assay “Holey fiber” based integral passive hydrostatic feed system with electrospray needle that would be used in an automated assay sampler. Several assay vials are shown, each containing different liquid samples. As the integral automated assay “Holey fiber” based integral passive hydrostatic feed system with electrospray needle assembly is placed into each vial, the combination of the integral assembly and vial are connected to the input of a mass spectrometer. Each individual vial would be tested with a fresh, sterile needle source.

### DETAILED DESCRIPTION OF THE INVENTION

In electrospray ionization mass spectrometry (ESIMS), one of the main expenses and a great percentage of the system is that of the hydrostatic feed system. Traditionally these are complicated, expensive, and sophisticated syringe pumps, capable of delivering a controlled and regulated amount of liquid, down to nanoliters [10⁻⁹ L]. Dr. John B. Fenn proposed using a passive, self-regulating feed system in the form of a wick. We all have experience watching a candle burning, and noticed how the flame keeps a perfect balance of melted wax and burning flame. As the melted wax is drawn up through the fibrous bundle we refer to as the “wick”, the flammable vapors from the melted wax are burned off at a constant rate while the heat of the flame melts the wax. The wick keeps the rate of burn and the rate of fuel supply in a constant balance, and hence the flame remains constant (actually it is more accurate to state—nearly constant, due to variations in the compounds that make up the wax, the imperfect structure of the fibers that make up the wick itself, and variations in surrounding air flow, that all contribute to slight perturbations in the flame to cause a slight flicker now and then). This ability of the wick to draw up liquid against the force of gravity is known a capillary action. Capillary action is the ability of a liquid to passively move itself through the mechanism of its adhesion and cohesion. There are attractive forces that exist between similar or “like” molecules of a liquid that will cause the liquid to stick together. This affinity for “sticking together” is known as cohesion, and will cause a drop of water to merge with other drops of water; the result is an ever-increasing, larger drop of water. Another important property of capillary action is that of adhesion. As dissimilar or “unlike” molecules interact, there is an attraction that can exist in varying amounts. In the case of water and glass, the water molecules are attracted to the glass molecules, and will be drawn towards the glass. If one has a small hollow glass tube, then the water will spontaneously start to rise up the tube against the force of gravity. As the amount of liquid increases by rising higher and higher up the hollow glass tube, or capillary tube, there will come a point where the weight of the liquid will exactly balance out the attraction between water and glass (adhesion). At this point the liquid will cease to rise any higher. For a liquid to rise in a capillary tube, the force of adhesion must be greater than that of cohesion. If the force of cohesion is greater than that of adhesion, the liquid will not rise, but drop lower than the surrounding liquid level, and down into the capillary tube. This is the case if mercury is used; the cohesive forces are greater than that of the adhesion.

For the most part, the wick fed candle is a marvel of nature, as there are no moving parts (not counting molecules and fluid flow) that can wear out, and it is entirely self-regulating. It would be cumbersome to construct a miniature pump that would both melt the wax and deliver a liquid flow at a regulated rate to keep the flame in balance. The difficulty would come in to play if one were asked to do this without any external power source and make sure it is reliable for a period of several years or decades. Needless to say, nature has provided a very elegant design to the problem of delivering a small, regulated amount of fuel to keep the system in perfect balance. Dr. John B. Fenn, immediately saw the potential benefit to of a wick based system to ESIMS. Nature has also provided a similar design to that of supplying water to plants and trees. Through the use of capillary action, the plant, and in like manner, the tree were designed with a liquid transport system utilizing capillary action. The tree and plant (actually the tree is a plant, but I use the term plant to distinguish relative size—a plant being small, like a single daisy, and the tree being large like a giant sequoia) both use a the same liquid transport mechanism that utilizes capillary action, but instead of small glass tubes, there is an equivalent vascular structure of tiny tubes running the length of the plants and trees called, Xylem and Phloem.

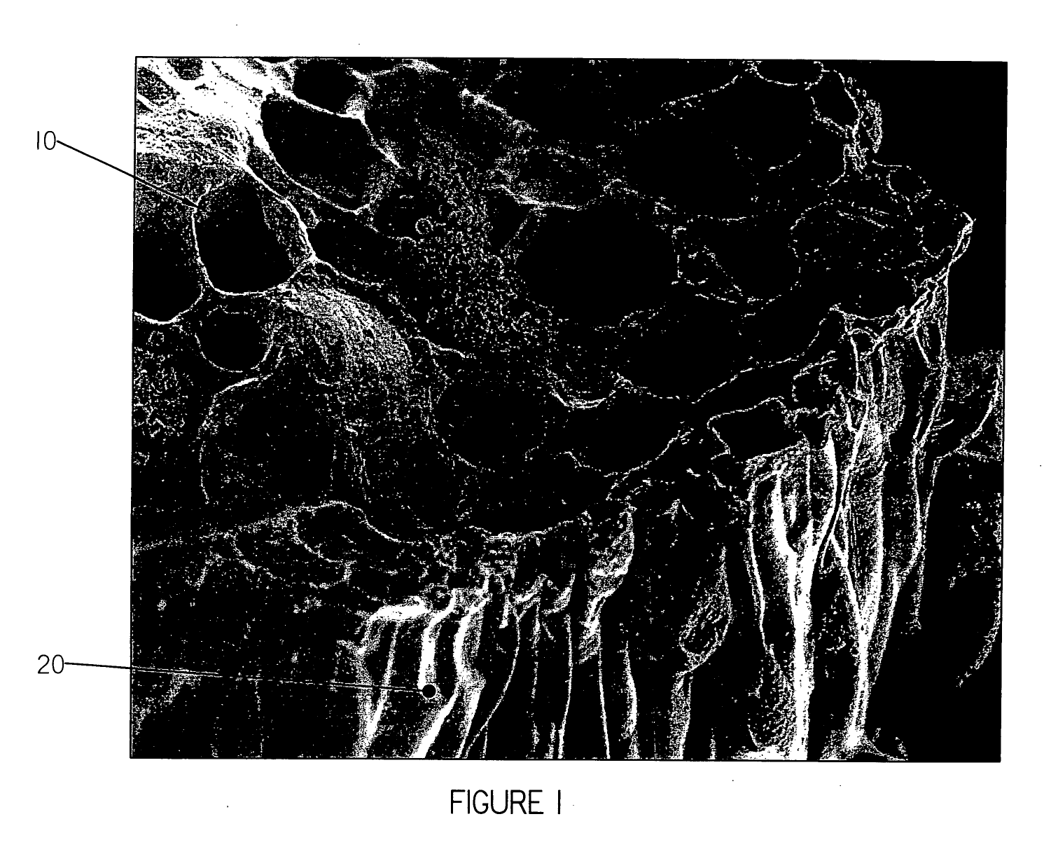

FIG. 1 illustrates a Scanning Electron Microscope (SEM) image or micrograph, of a section of the vascular Xylem and Phloem tissue structure running throughout the length of the organism. The Xylem and Phloem together form a continuous vascular system 20 that runs lengthwise throughout the plant providing both water, nutrients and structural stability. Multitudes of small holes 10 of varying sizes are formed inside the fibrous bundle of material to establish the capillary action required to transport liquid throughout the organism. It is this continues network of holes running throughout the length of the plant that were the inspiration for using glass “Holey” optical fibers as a passive fluid delivery system. Although there exists several techniques for drilling or producing small holes in glass, there are limitations as to the size and depth of those holes. Most places that actually drill through the glass have a size limit of about 4 or 5 thousandths of an inch in hole diameter, and for only a depth of about ⅛ of an inch. A glass wick would require holes on the order of micrometers (μm) in diameter and running the entire length of the wick structure, with the length from as small as a quarter of an inch, to as long as several feet. If a laser is used to drill tiny holes in the glass structure, then the limitation of a short depth is encountered. To construct an acceptable wick with the desired capillary hole size ranging from several micrometers in diameter to sub-micrometer diameters through the length of the glass structure, only one item has been found to fit the bill—Holey fibers.

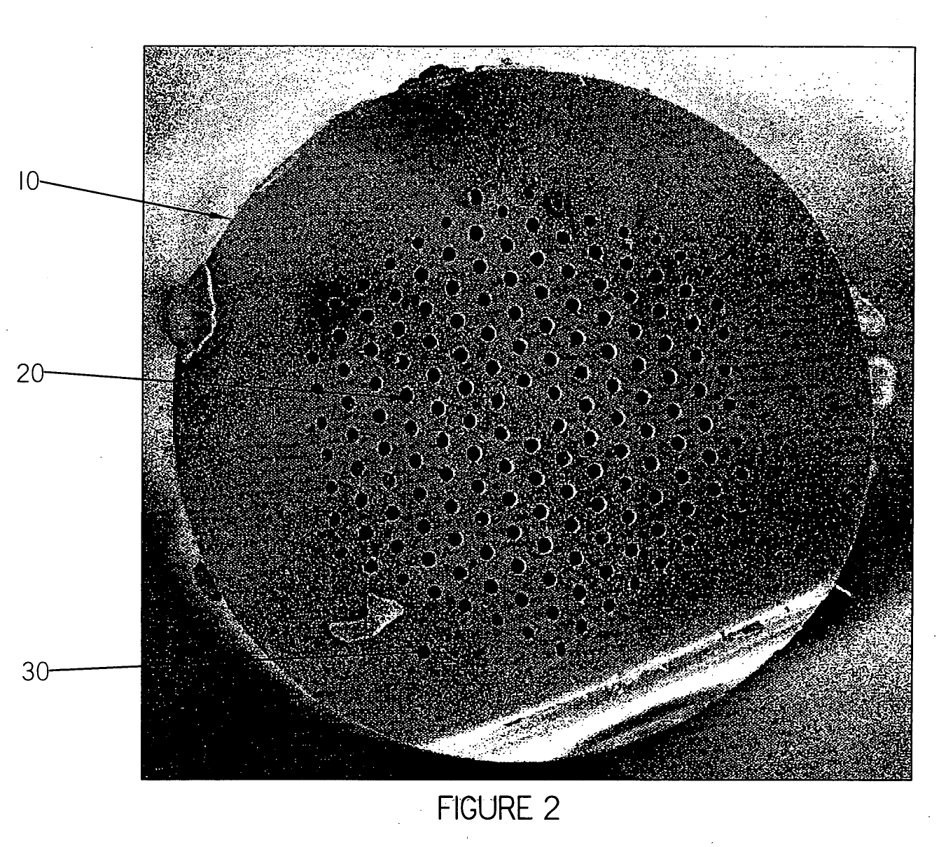

FIG. 2 shows a SEM micrograph of one of the holey fibers. Holey fibers are a relatively new class of optical waveguide that use an array of tiny hollow channels, or holes 20, to guide light in a novel way. A team of scientists at the Optoelectronics Research Center (ORC) at the University of Southampton, UK, have developed a process for producing optical fibers with uniform hole diameters ranging from about ½ μm to as large as tens of micrometers, with an overall fiber diameter 10 of around 200 μm with lengths as much as several kilometers. The core material is silica glass 30, and is virtually identical to that used in the core and cladding of traditional optical fibers, the difference comes in the fact that there is no cladding surrounding the core. Traditional optical fibers have a core glass material surrounded with a glass cladding material, each with different indexes of refraction that are designed to “guide” light through the fiber using internal reflection. “Holey fibers” don't have the need for a cladding material to surround the core; the holes running through the core interact with the photons and serve to guide the photons through the “Holey fiber”. The process for confining the light utilizes the Photonic Band Gap principle. The ability for light to behave this way has only recently been understood and is more complex than the traditional refraction interfaces that comprise a traditional optical fiber. Although silica glass is specified, the fiber could also be made from quartz or a suitable polymer.

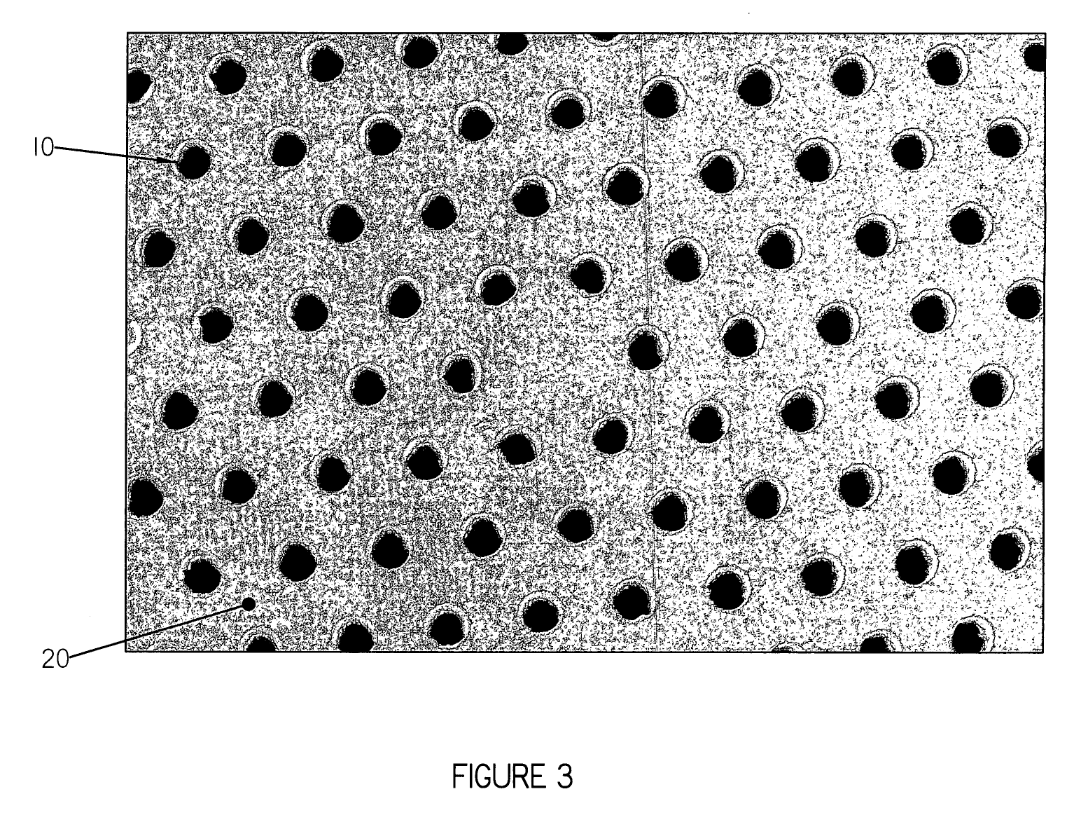

FIG. 3 shows a SEM micrograph of a close up view of the front face of the holey optical fiber. The holes 10 are shown to be arrayed in a regular, repeating fashion throughout the core glass material 20, although this is important for optical applications, for fluid applications a single hole would function adequately, with a plurality giving a greater quantity of liquid to increase throughput. By using these “Holey fibers” as a wick for electrospray applications, highly efficient needle sources could be produced to form a self-regulating feed system. The Idea of using a wick as a self-regulating capillary feed system that eliminates the necessity for a hydrostatic feed pump was first proposed by Dr. John B. Fenn. Dr. Fenn, who is a pioneer of electrospray ionization mass spectroscopy (ESIMS), was recently awarded the Nobel Prize in chemistry (December 2002) for his contributions to the art. Electrosprays are an advanced stage of the phenomenon known as Zeleny-Taylor cones. When a liquid drop is subjected to an electric field, it will become slightly elongated in the direction of the field. Since the dielectric constant of the drop is larger than that of the surrounding air, the elongation of the drop effectively channels more of the field inside the dielectric material, lowering the overall energy stored in the electric field. This elongation is opposed by the surface tension of the drop, which tends to keep the drop close to spherical shape. As the field is increased, the drop will continue to deform from its preferred spherical shape. When this happens, the tip of the drop reduces its radius of curvature with more electric field concentrated at this point. This mechanism feeds back into further deformation. At a critical field and deformation known as the Rayleigh limit, the rate of energy gained by raising the electric field inside the dielectric drop is no longer offset by the energy lost due to surface tension, and the drop unstably progresses toward a very sharp tip. This phenomenon we first seriously studied by Zeleny around 1915. G. I. Taylor published a famous paper where he calculated the angle of the conical drop. Since then, the drops are called Zeleny-Taylor cones, or simply “Taylor cones”. A major portion of any ESIMS is that of the hydrostatic feed system. The hydrostatic feed system must be capable of delivering a tiny amount (microliter to nanoliter quantity) of liquid at a controlled rate to effect a stable Taylor cone. The disclosed invention will use a small section of “Holey fiber” to act as the small, wick filled needle source for electrospray applications. The “Holey fiber” could then enable smaller, lighter, and less costly ESIMS units to be produced, in addition to the added benefit of being a perfect electrospray source and self regulating liquid delivery source for small, micro and nano satellites for space applications. The fact that there will be no moving parts in this self regulating liquid delivery source means that the reliability and longevity will be greatly enhanced. The Holey fiber wick is capable of delivering a regulated flow rate down to a range of Picoliters [10⁻¹² L] per second. To design a small syringe pump to do the same job would be extremely large and costly to implement.

By using a “Holey fiber” to create a miniature, passive fluid feed system, a smaller, cheaper, and more sensitive electrospray ionization mass spectrometer (ESI-MS) could be realized. The smaller size and lower cost would enable the creation of portable ESI-MS's to have an increased usage in field applications. The application to on-site forensics and remote Pharmaceutical investigations will enable quicker turn around of results. By having a small, handheld ESI-MS, one could do quick investigations into environmental disasters, forensics of a crime scene, rapid analysis of flora and fauna in areas like the Rain forest to come up with cure for diseases like Cancer, rapid analysis of various underwater sea life, such as deep sea sponges, or various fish, seaweed and crustaceans, and even cost effective methods of improving quality control of chemicals, medicines and pharmaceutical compounds. In some cases there is only a small quantity of compound or analyte to work with, and even with the best commercial ESI-MS to work with, the sample could only last for a few seconds, with the results masked by noise. A way to improve the signal to noise ratio (SNR) would be to have more analyte to process, or to enable the amount on hand to be used more slowly. If a smaller electrospray needle were used, then a smaller amount of analyte would be used per unit time. The problem then exists with a syringe pump; a volume of liquid must be present to be pumped through the syringe pump into the needle. After a certain amount of time, some volume of liquid is “wasted”, in the sense that the syringe pump has reached its maximum deflection or movement and can no longer push any more analyte through to the needle. With the invention described, a smaller amount of analyte could be used, and since the holes in the Holey fibers are on the order of a few microns, the volume of analyte on hand will be used up more slowly, and hence, the amount of time available to analyze the analyte will be increased. This increase in analysis time will improve the overall systems SNR, and the sensitivity of the ESI-MS. One more advantage of using a holey fiber passive fluid feed system is that there is no longer any need to have a “frit” or filter structure to prevents clogging. In an electrospray needle source used in traditional ESI-MS, the tiny needle must be cleaned after each run, and may become clogged over time. The disclosed invention does away with having to clean the electrospray needle source because a fresh electrospray needle (Holey fiber) and sample cell would be used each time. Another advantage of using Holey fibers as a fluid feed mechanism is the fact that the analyte will regulate itself, and nearly 100% of the solution (both analyte and solvent) will be utilized. There is very little wasted fluid due to interconnecting tubes or hoses from a syringe pump. An additional advantage is that each “Holey fiber” wick could be made into the tip of a small vial to be placed into an auto-sampler type tray so that each analyte to be analyzed on the ESI-MS will have a clean and uncontaminated electrospray fluid delivery system and needle. The “Holey fiber” would serve, as not only the fluid feed system, but also the electrospray needle. Every vial used would contain its own “syringe pump” and electrospray needle. No cleaning of the electrospray needle or syringe pump is required in the mass spectrometer. By using the described invention, the rate of analyzing compounds with an automated ESI-MS would be greatly increased due to the fact that each sample vial or container would contain its own holey fiber wick, that serves as both the syringe pump and electrospray needle. There will be no need to purchase an electrospray needle for the ESI-MS, as each sample vial will contain its own electrospray needle—the “Holey fiber”.

Using a different Holey optical fiber could vary flow rates. A low flow rate would be realized with a Holey fiber containing holes as small as half a micron or less, while a higher flow rate would be realized by using a Holey fiber containing holes as large as 20 or 30 μm. The size of the holes in the “Holey fiber” could be balanced with the number of holes contained in the fiber. By using smaller holes, a lower flow rate would be realized. Some previously created Holey fibers have hole diameters around 4.7 μm and 168 holes in the fiber. If a higher flow rate were needed, the number of holes could be increased, or the diameter of the individual holes could be increased. Different combinations of hole size and number of holes could be used.

In the area of space propulsion, there exists a low thrust mechanism known as colloidal propulsion. The amount of thrust is typically in the micronewton range [10⁻⁶ Newton], and is used as more of an attitude adjustment or in the case of a constellation of satellites, to balance the effect of Solar wind. Colloidal propulsion uses electrospray to create a fine jet of droplets that are accelerated away from an electrospray needle at a high rate (up to several times the speed of sound). The advantage of using a colloidal thruster for propulsion is that it is one of the few controllable methods of producing tiny amounts of thrust. Chemical rockets are normally used for high load applications where a great amount of mass has to be accelerated (Space Shuttle, Saturn V Rocket, etc.) To effect a small amount of controlled thrust, a metering mechanism must be employed to deliver a controlled, and precise amount of propellant. The use of valves and pumps increases not only the complexity of the device, but also the weight and cost. The reliability of the system would be greatly reduced by the complexity of sophisticated pumps and valves. Dr. John B. Fenn and Joseph J. Bango Jr. proposed a method to eliminate the complexity and increase the reliability of operation—the use of a wick based fluid feed system. One major disadvantage of this system is the problem creating a suitable wick. The needle must be small to limit the exposure of the propellant to space, and this presents a problem for placing a fibrous wick material inside a small bore needle.

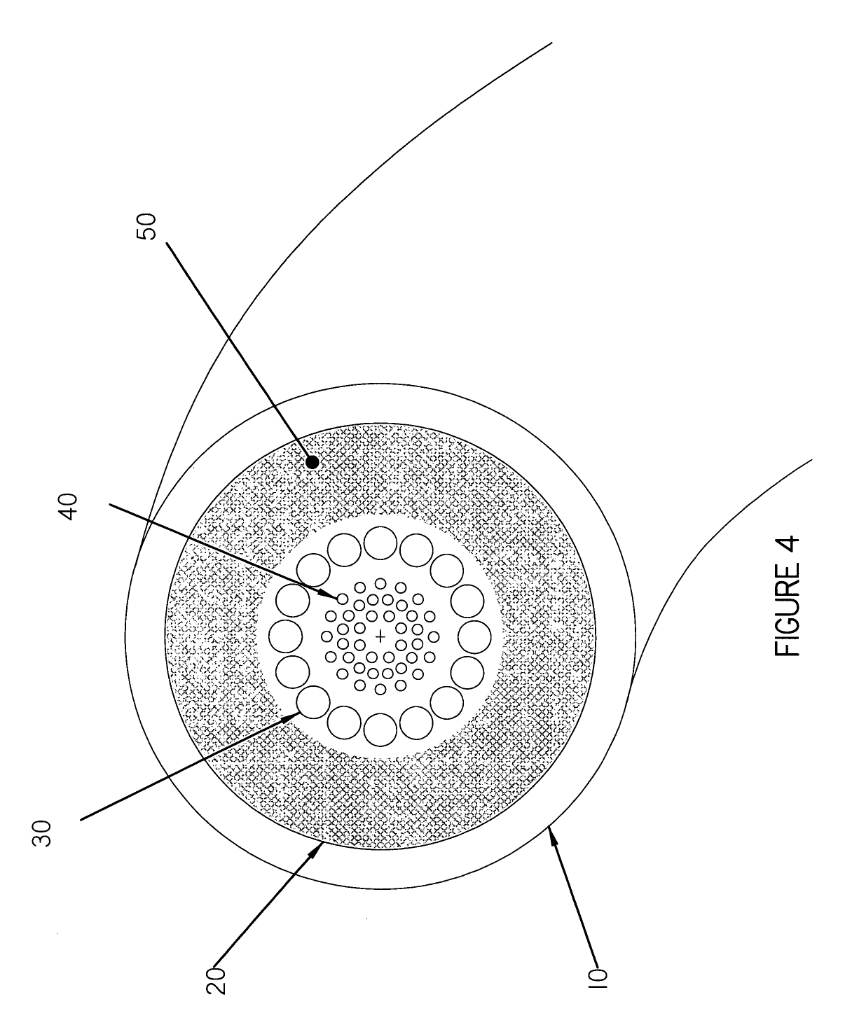

FIG. 4 describes a preferred embodiment of a possible passive coaxial fluid feed system. The described invention solves this problem by both having holes that are on the order of 5 μm and are completely covered (except the two ends of course), thereby limiting the exposure of the colloidal fluid to the vacuum of space. A fluid with a low or near zero vapor pressure will not evaporate in the vacuum of space, but will have only a nominal amount of thrust. A colloidal fluid with a slightly higher vapor pressure will have a greater amount of thrust, but will evaporate prematurely if exposed to the vacuum of space. If the exposure to space were limited, as in the case of a “Holey fiber”, then the amount of evaporation could be controlled and kept to a low value. This would make a higher vapor pressure colloidal fluid a viable candidate for space applications. The “Holey fiber” acts as a sheathed or covered wick, and thus limits the exposure of the liquid to a high vacuum environment, such as space. In the area of space propulsion it would be preferable to have a plurality of “Taylor cones” to increase the overall thrust. If the surface of the holey optical fiber were treated to make it hydrophobic 50, that is to make it repel liquid, then each individual capillary, would behave as an individual electrospray needle source. The benefit would be that each capillary would have a minimum amount of exposure to a high vacuum environment. One such way to treat the holey optical fiber would be to use a chemical such as Hexamethyldisilazane. If the end to be used as the electrospray source is placed in a small quantity of solution while having a tiny amount of air passed through the holey fiber, then this will prevent any of the chemical from being pulled into the capillary holes of the “Holey fiber”, and would interfere or eliminate capillary action. The larger diameter holes 30 would be used to supply a low vapor pressure oil or viscous liquid to act as a protective coating that will be used to coat a liquid with a higher vapor pressure to slow its rate of evaporation in a harsh environment, such as the vacuum of space. The smaller diameter holes 40 would be used to supply a high vapor pressure liquid that is intended to be covered with the low vapor pressure oil or liquid so its rate of evaporation in a harsh environment, such as the vacuum of space, will also be limited. The smaller hole size 40 will limit the exposure of the high vapor pressure liquid to the vacuum of space. An outer protective coating 10 would be used to cover the glass core to prevent scratching or damage. The material that comprises the “Holey fiber” 20 would be silica glass. The glass fiber core face 50 is treated to make it hydrophobic, preventing the liquid solution from reaching the outer edge of the glass holey fiber. The intent is to confine the two liquids to the center of the glass holey fiber to permit mixing, or coating of the higher vapor pressure liquid. The higher vapor pressure liquid will give a higher thrust for colloidal propulsion applications in space, but will evaporate quickly, due to its higher vapor pressure. In addition to coating different chemicals with different vapor pressures, binary compounds could be used that would be combined only at the exit of the “Holey fiber”. The different sized holes could now be uniform in size, and would permit mixing or combining of various chemical species under controlled conditions. The different chemical compounds may be of a nature that they are highly combustible or explosive when combined together, but inert after combination. If two dangerous chemicals are combined utilizing a co-axial “Holey fiber” under specific conditions, such as in an inert atmosphere like nitrogen, then new and novel compounds could be created.

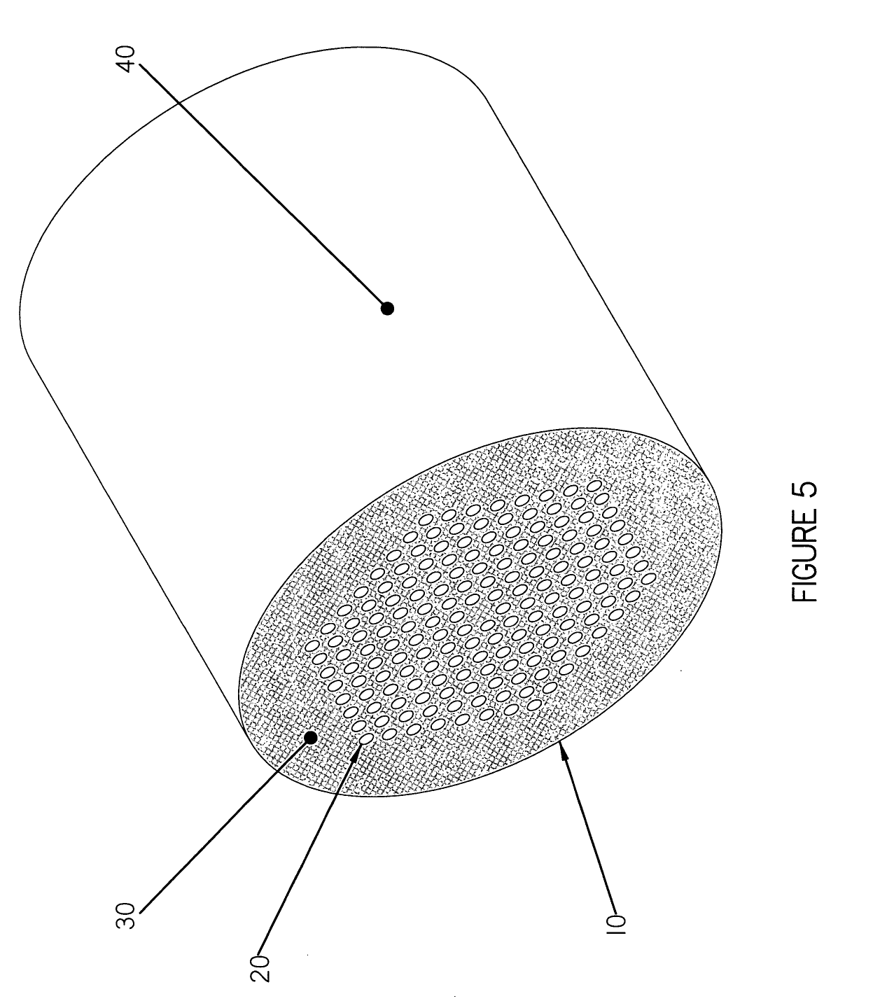

FIG. 5 details a three-dimensional image of the “Holey fiber” that will comprise the heart of the passive, regulated, liquid feed system. The capillary action of the glass fiber 40 will cause a repeatable and regulated flow of liquid to be transported through the capillary holes 20. When used in an ElectroSpray (ES) propulsion mode, the plurality of capillary holes 20 would provide additional thrust, due to the fact that there is more liquid to exit the “Holey fiber” 40. To provide more controllable thrust in a propulsion mode, the surface portion 30 of the “Holey fiber” 40 would be treated to make it hydrophobic. This would have the benefit of preventing a large mass of liquid from being created from several adjacent capillary holes 20. When the end section 10 of the “Holey fiber” 40 is treated to make it hydrophobic 30, each individual capillary 20 would have its own so-called “Taylor cone”, and thus, a source of electrospray. This would allow for the 168 individual capillaries 20 to produce 168 individual Taylor cones, or in this case, 168 emission sites for producing thrust or if used as a source of spray for pheromones, scented oils, or liquid “odor neutralizing” perfumes or sprays. With the plurality of holes, more liquid could be transported through the “Holey fiber” 40 in a controlled and regulated fashion. Conditions sometime exist where the size of the capillary holes are too small, or the liquid of interest has too great a contact angle to be transported by capillary action alone—in this case the applied electric field would effectively “pull” the liquid through the capillary holes 20. A definite commercial use is provided for when using “Holey fibers” as an aerosol generator. Virtually any liquid, or solid (if used with an appropriate solvent or transport liquid) that can conduct electricity is compatible with the “Holey fiber” passive, liquid feed transport system. If a solution has a contact angle (referring to the capillary action of the liquid to the glass walls of the individual capillaries in the “Holey fiber”) that limits it ability to be drawn through the capillary, then with the application of the electric field necessary for the ES system, will “pull” or force it through. The pull from the electric field and the rate of fluid resistance due to capillary action will help to regulate the flow of the liquid through the length of the “Holey fiber”. Different length “Holey fibers” would contain different strengths of electric field (shorter lengths—more electric field, longer lengths—less electric field), and thus different flow rates with the same applied electric field. As the applied electric field is varied in magnitude, a greater field will provide a greater amount of continues flow. If the applied electric field is too high, then the capillary action would limit the amount of fluid provided, and a sputtering action would occur. This sputtering action would be detrimental in a space thruster application, as it would produce non-continuos thrust, or intermittent spurts of unequal thrust, which would be manifested as thrust noise. In addition to the number of capillary holes 20 and length of the fiber itself has on the overall amount of liquid that is transported and regulated, the “Holey fibers” also have the ability to be manufactured with different sized capillary holes 20 that will allow for the overall amount of liquid to be modified. A “Holey fiber” could be made with larger or smaller capillary holes 20, ranging anywhere from sub-micron sized holes (<10⁻⁶ m), to several tens of microns in diameter. It is important to note that the number of holes stated previously (168) is not a limiting factor in the described invention. This number could be anywhere from one single capillary, to several hundred.

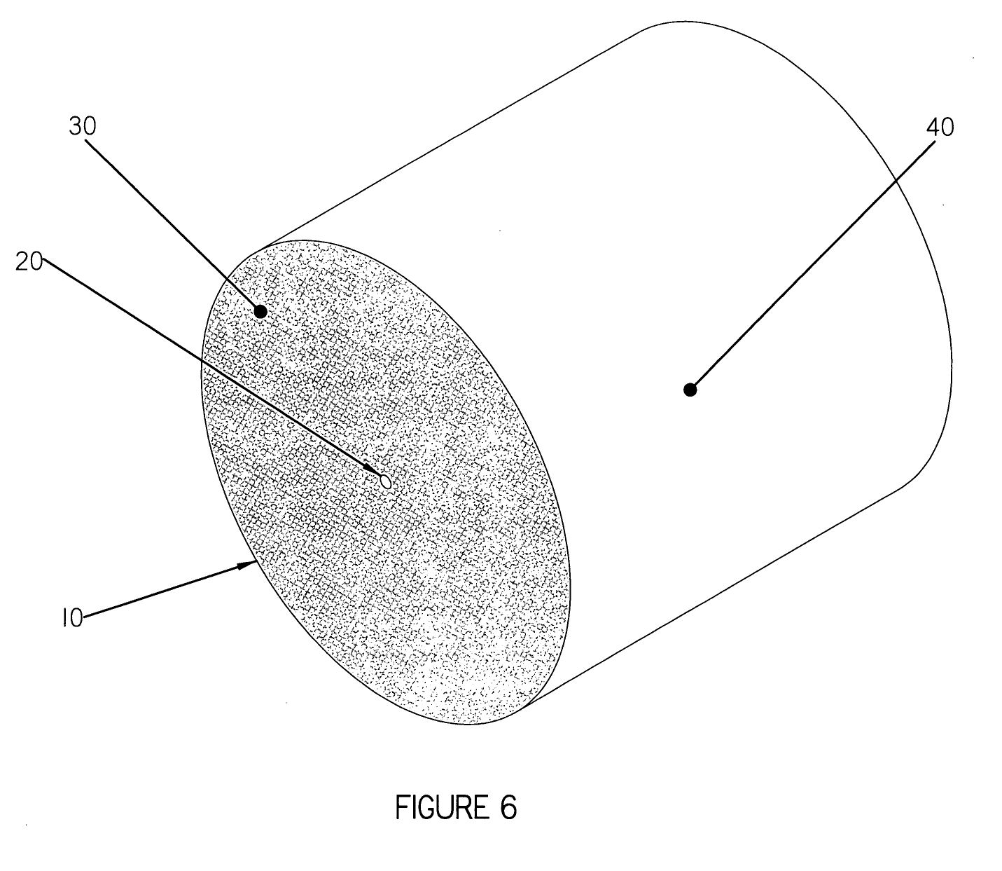

FIG. 6 details a three-dimensional image of another “Holey fiber” that will comprise the heart of the lower flow (minimum quantity); passive, regulated, liquid feed system. The capillary action of the glass fiber 40 will cause a repeatable and regulated flow of liquid to be transported through the single capillary hole 20. When used in an ElectroSpray Ionization Mass Spectrometer (ESI-MS), the single capillary 20 would allow for a minute amount of liquid sample to be slowly introduced into the ESI-MS. In traditional ESI-MS systems, there is a hydrostatic liquid feed system that is nothing short of a small syringe with the plunger controlled by a geared stepper motor to provide a small but discernable amount of force to the plunger, which in turn would force the liquid contained inside the syringe in the ElectroSpray needle of the ESI-MS. The problem with this method is that when the plunger is fully extended, any liquid left inside the syringe or that is left inside any connecting tubing from the syringe to the entrance to the ElectroSpray needle will stop moving, and thus be wasted. The “Holey fiber” system has the advantage in that virtually all of the liquid will be transported through the capillary structure of the “Holey fiber”. When running a small amount of sample on an ESIMS, the goal is to get as much of that limited amount into the ESI-MS for testing. If a “Holey fiber” is used as the alternative to the complex syringe pump, connecting tubing, and ElectroSpray needle, then the amount of liquid needed to run a sample is greatly reduced, as well as the amount of waste. With a “Holey fiber” liquid feed system, much smaller amounts of sample could be tested, and also the testing time for a small quantity of sample could be greatly increased, adding an increased signal to noise (S/N) ratio to the ESI-MS. Due to the fact that the described single bore “Holey fiber” has only one capillary opening 20, the hydrophobic surface 30 may or may not be needed.

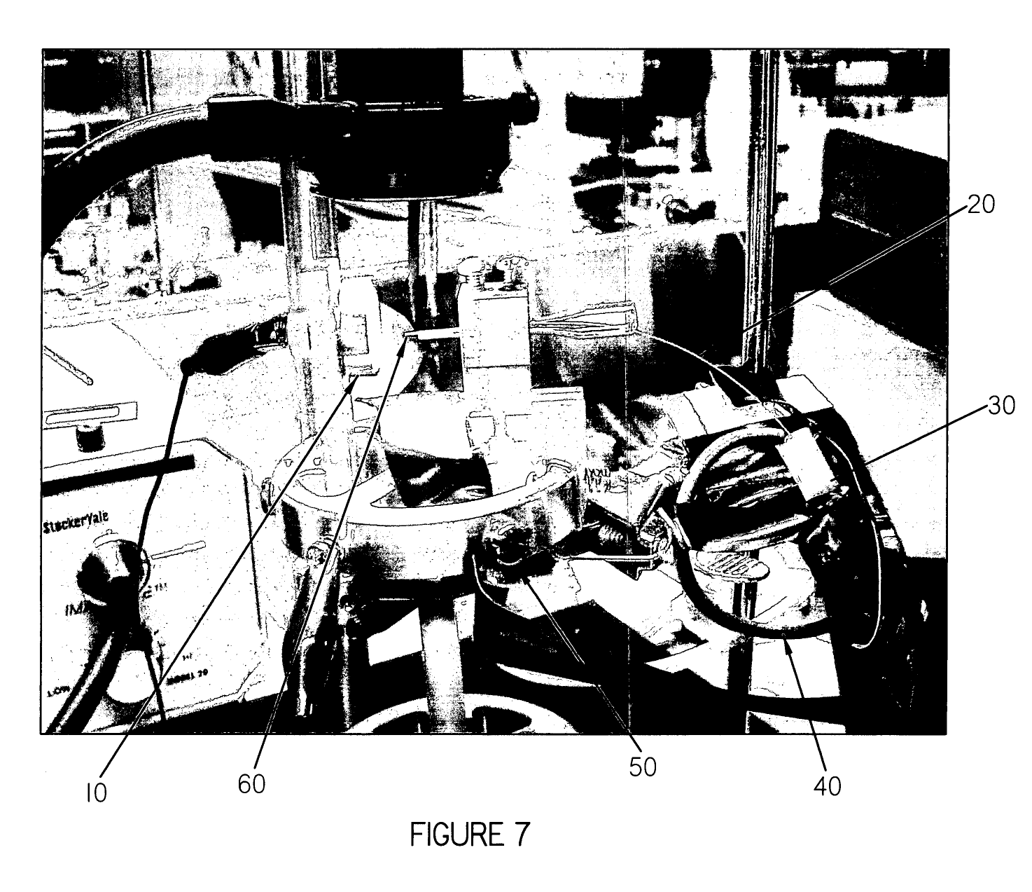

FIG. 7 shows a photograph of the inventors' laboratory setup at Connecticut Analytical for testing the “Holey fibers” for ElectroSpray applications. The photograph shows the “Holey fiber” itself 20 that was used to take the place of a traditional ESIMS hydrostatic feed system, connecting tubing, and ElectroSpray needle. The liquid reservoir 30 contained a 50/50 solution of 1-Propanol and distilled water. Instead of the ElectroSpray needle having an applied high voltage as in traditional ESI-MS, the stripped high voltage connection wire 40 was placed directly inside the liquid reservoir 30. The high voltage return (ground wire) 50, is connected to the conductive target support 50. The target 10 was held at a ground potential and was placed about ¾ of an inch away from the tip of the “Holey fiber” 60. The length of “Holey fiber” 20 used in this test was 4.13 inches in length, and contained 168 capillary holes, each with a diameter of approximately 8.0 um. This test was performed for a variety of “Holey fibers” of different lengths and different sized diameter holes ranging from the smallest at 4.1 um to the largest at 12.3 um. The “Holey fiber” will work at both atmospheric and vacuum conditions.

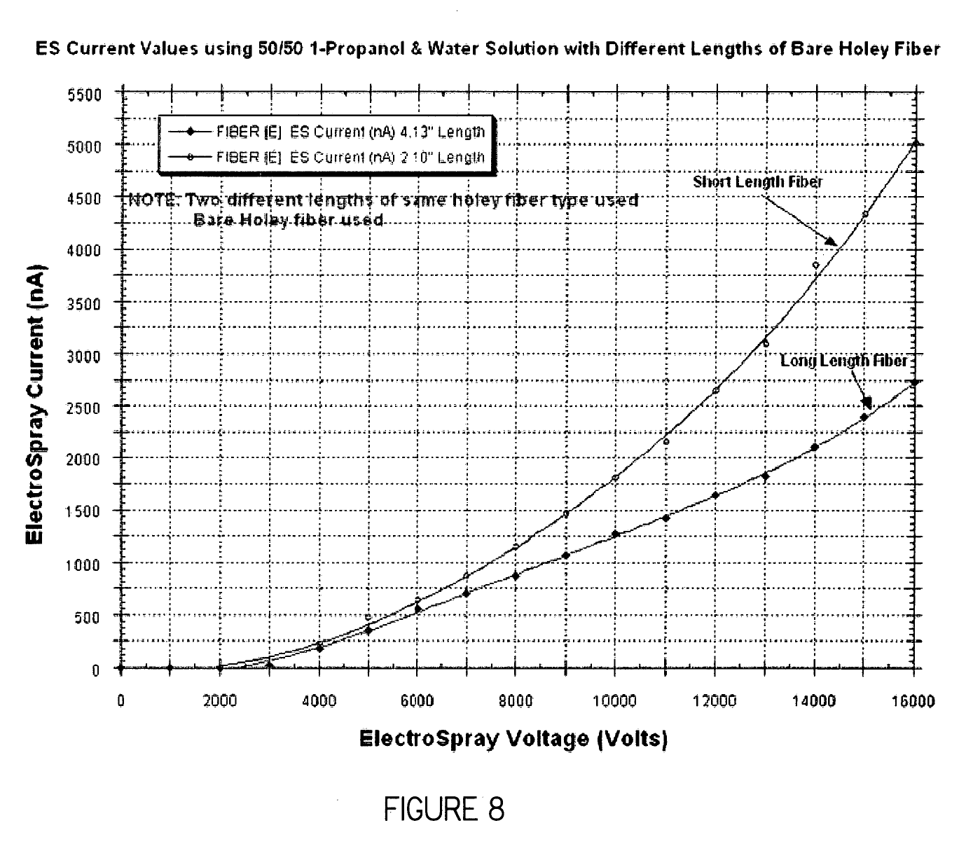

FIG. 8 shows a graph of ElectroSpray current (in Nanoamps 10⁻⁹ Amps) versus applied ElectroSpray voltage (in volts). With a long length of bare “Holey fiber” of 4.13 inches in length, the overall amount of ElectroSpray current is less than that of a shorter length of bare “Holey fiber” with a length of 2.10 inches in length. The voltage range went up to a maximum of 16,000 volts DC, positive with respect to the grounded target used in the previously described laboratory setup. The ElectroSpray current has a direct relationship to the amount of emitted ions, as more ions are emitted per unit time, the overall ElectroSpray current increases. The graph was made by using untreated, bare “Holey fibers”. The end was not treated to make it hydrophobic, so each individual capillary hole in the “Holey fiber” was not establishing its own Taylor cone, and hence, its own emission site. If the fiber were treated to make the end hydrophobic, then a slightly greater amount of ElectroSpray current would be realized. The hydrophobic surface must only coat the external face of the “Holey fiber” and must not coat the inner portion of any of the capillary holes. If the capillary holes are made hydrophobic, then the capillary action will cease or be reduced.

In the area of aerosol generation such as dispensing scented oils or perfumes, the “Holey fiber” fluid feed system could provide a useful and cost effective solution. Because the “Holey fiber” fluid feed system uses no moving parts, an economical aerosol generator could be fashioned that would enable a highly efficient, reliable, and small sized product. With a low rate of regulated fluid delivery obtainable from a “Holey fiber” fluid feed system, a small quantity of scented oil or perfume could last for an extended period of time and would not require any external fan.

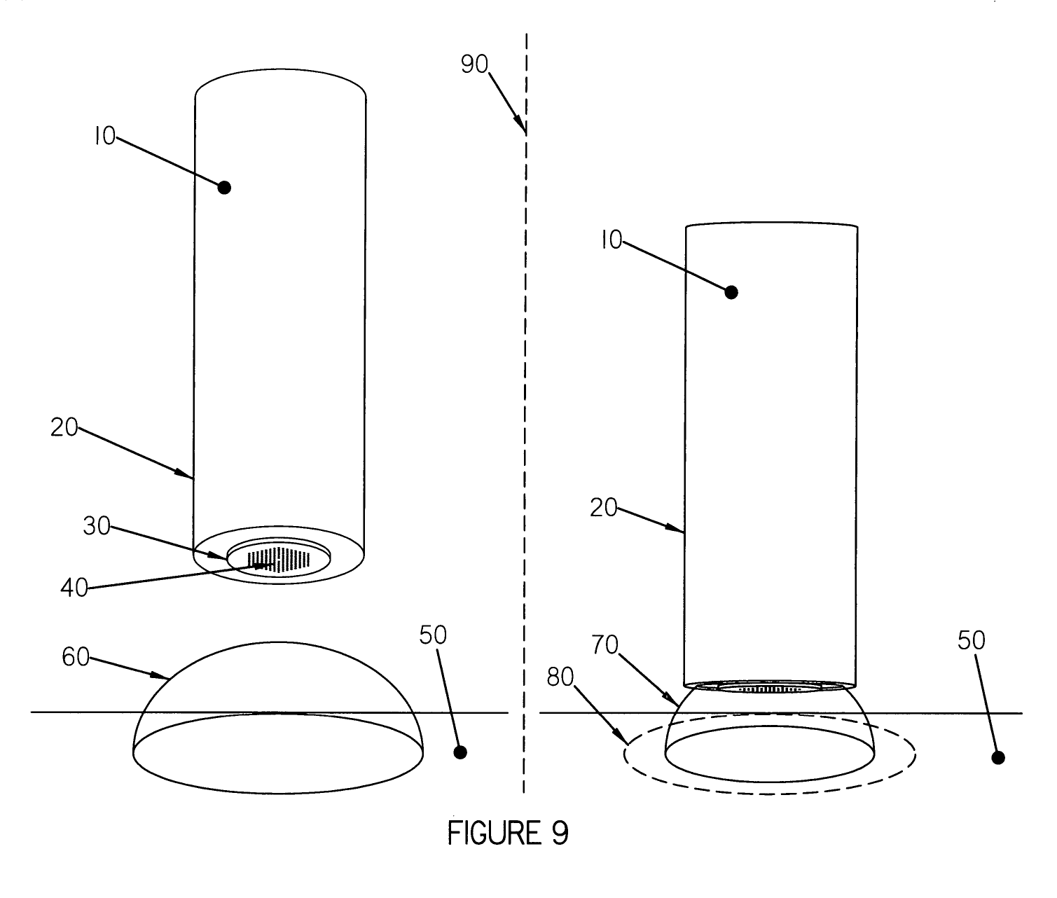

FIG. 9 shows a detailed process of using a “Holey fiber” to collect minute samples for either research or forensic collection. The left side of the image indicates the pre-collection process, while the right side of the image indicates the actual collection process. A vertical dashed line 90 is used to indicate the distinction between pre-collection and collection separates the left and right side of the images. The bare “Holey fiber” 30 is too brittle and fragile to be used effectively by itself, so it must be shrouded or encased inside a rigid support structure 20. The combination of the bare “Holey fiber” 30, and rigid support structure 20 comprises a complete capillary collection tube 10. By having a rigid outer tubing 20 enclosing the bare “Holey fiber” 30, the individual using a capillary collection tube 10 would not need to be so delicate when using the device for collecting samples. The external support structure 20 could be composed of a rigid, transparent polymer, a thicker layer of glass that would have the benefit of being chemically inert, or a thick, opaque metal tubing for ease of handling. The preferred embodiment of the invention would use a thick glass outer casing 20 to provide additional strength, while allowing for optical transparency. When the transparent glass external covering 20 is used, a variety of analytical devices could be used to perform tests on the acquired liquid sample. Some of the tests could be performed using a spectrophotometer to analyze the liquid stored in the capillary holes 40 running through the length of the “Holey fiber” 30, or even making fluorescence or phosphorescence measurements. If the sample to be analyzed is in liquid form such as a droplet 60 on a non-porous surface 50, then the capillary action of the “Holey fiber” 30 due to the capillary holes 40 running through its length will “wick up” some of the liquid. In the right side of the image (left and right are separated by a vertical dashed line 90), the capillary collection tube 10 is making physical contact with the droplet of liquid 70 to be sampled. As a small quantity of liquid is pulled up into the capillary holes of the glass fiber, the resultant volume, and hence size of the droplet shrinks. The original size of the droplet 80 is indicated by a circular dashed line. Once enough liquid 70 is pulled into the capillary holes, it can be sent to a laboratory for processing and analysis. It has been stated that the sample is liquid, but this does not have to be the case. If a dry, powdery substance warrants investigation, then a suitable solvent (such as water or alcohol) could be used. If a small amount of solvent is poured onto the dry powder, then the resultant solution could be sampled by the capillary collection tube 10. Several analysis methods could be used to investigate the collected sample and as stated before, optical methods could be employed, or the sample could be sprayed directly into a mass spectrometer for detailed analysis. In the optical method, a UV (ultra-violet) laser or intense UV light source could be shone directly onto the sampled liquid/solution contained inside the capillary holes 40. Since the glass fiber and external support is transparent (in the case if glass is used), the light source would not be attenuated too much before reaching the liquid/solution. The resultant interaction between the UV source and the sample contained inside the capillary holes 40 would cause the sample to be placed into a gaseous form for analysis with several types of mass spectrometers. The sample could be placed into a gaseous state by heating it to a high temperature. If the opaque metal external support is used, then optical methods would not work, but heating and/or suction would work well.

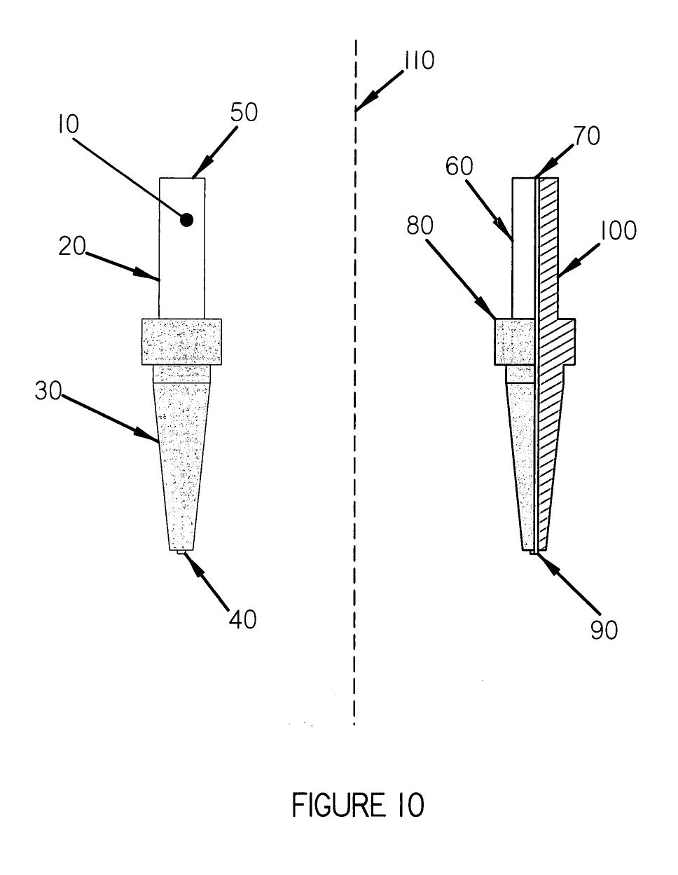

FIG. 10 shows a detailed image of an automated assay “Holey fiber” based integral passive hydrostatic feed system with electrospray needle. The left side of the image shows a complete view of one of the disposable, “Holey fiber” based integral passive hydrostatic feed system with electrospray needle, while the right side of the image details a cut-away view of the disposable, “Holey fiber” based integral passive hydrostatic feed system. A vertical dashed line 110 is used to indicate the distinction between the left and right sides of the image. The bare “Holey fiber” 70 is too brittle and fragile to be used effectively by itself, so it must be shrouded or encased inside a rigid support structure 10. The combination of the bare “Holey fiber” 70 encased inside the rigid support structure 10 will enable the realization of a robust, yet disposable sampler system for use with a mass spectrometer. The disposable, “Holey fiber” based integral passive hydrostatic feed system 10 is designed to replace the complicated and expensive hydrostatic feed pump used with electrospray mass spectrometers, along with the electrospray needle. By using a separate disposable, “Holey fiber” based integral passive hydrostatic feed system 10 for each sample vial; the cost and complexity of the mass spectrometer could be reduced, along with its size. This would allow for prolific field use of mass spectrometers that will be able to be made smaller and more portable. By using a separate disposable, “Holey fiber” based integral passive hydrostatic feed system 10 for each sample vial, the possibility of contamination of samples is all but eliminated, and the purity of the sample quality is kept pristine. Since a new electrospray needle is used each time, then the possibility of clogging is also eliminated. The preferred embodiment of the invention shows a non-conductive polymer 100 that will be used to encase the single “Holey fiber” 70. Since the polymer is non-conductive, a means of charging the analyte is needed, for this a metalized plating 30 is coated onto the surface of the disposable, “Holey fiber” based integral passive hydrostatic feed system 10. It is also possible to manufacture the disposable, “Holey fiber” based integral passive hydrostatic feed system 10 out of a conductive polymer, in which case the metalized plating is not needed. When a high voltage connection is applied to the metalized portion 30 of the disposable, “Holey fiber” based integral passive hydrostatic feed system 10 by means of a removable contact making a connection to the extended stop portion 80 shown in the right side image. The extended stop portion 80 serves two purposes, as a physical stop for preventing the integral sampler from being pushed too far into a sample vial and also a large surface area for connecting to a high voltage source. The non-metalized portion 20 & 60 will be placed into the entrance of the mass spectrometer. The top portion 50 is also not plated and will remain non-conductive. The “Holey fiber” 70 is placed in the center of the disposable, “Holey fiber” based integral passive hydrostatic feed system 10 and is ground perfectly flat at the top 50 and only cleaved at the bottom 40 & 90. The top, ground portion 50 is placed inside the entrance to the mass spectrometer, while the exposed, untreated end 40 & 90 is to be inserted inside a vial containing the analyte liquid. The top, ground portion of the “Holey fiber” 70 can be left untreated, or treated to make the end surface hydrophobic. This will help to ensure that each capillary hole can create its own individual “Taylor cone” for an electrospray jet when placed inside the mass spectrometer. An extractor will be required to be placed in close proximity to the ground end 50 of the assembly when used in a mass spectrometer to create the “Taylor cone” and subsequent electrospray. When a high voltage is applied to the metalized coating 30, the liquid will be fed into the mass spectrometer and undergo the creation of a Taylor cone and subsequent coulomb explosions inside the mass spectrometer.

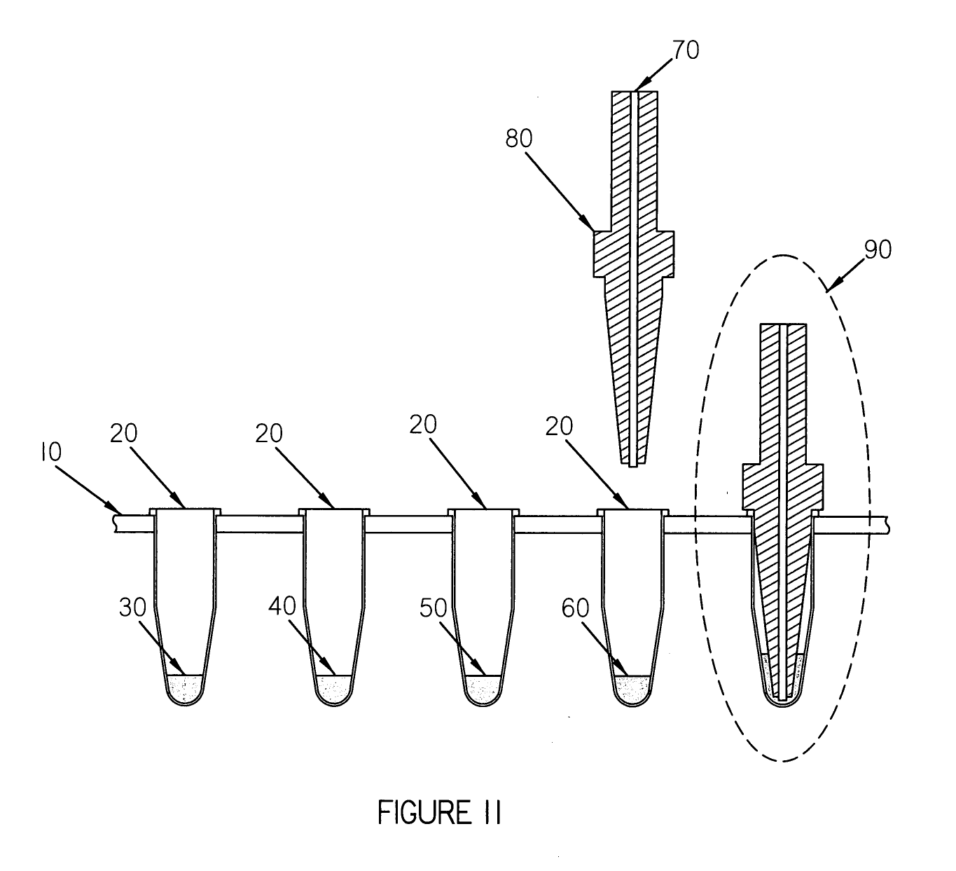

FIG. 11 shows a detailed image of an automated assay “Holey fiber” based integral passive hydrostatic feed system with electrospray needle (previously described in FIG. 10) and several vials containing liquid analyte samples to be tested on an automated sampling system. A elliptical dashed line 90 is used to indicate the distinction between the separate vial and sampler assembly and the combination of the sampler assembly placed inside a vial containing liquid analyte. The elliptical dashed line 90 is indicating a completed unit. The bare “Holey fiber” 70 is too brittle and fragile to be used effectively by itself, so it must be shrouded or encased inside a rigid support structure 80. The combination of the bare “Holey fiber” 70 encased inside the rigid support structure 80 will enable the realization of a robust, yet disposable sampler system for use with a mass spectrometer. The disposable, “Holey fiber” based integral passive hydrostatic feed system is designed to replace the complicated and expensive hydrostatic feed pump used with electrospray mass spectrometers, along with the electrospray needle. By using a separate disposable, “Holey fiber” based integral passive hydrostatic feed system for each sample vial for automated testing; the speed and throughput of testing a large quantity of unique analyte samples could enable greater cost savings for large laboratories and forensic laboratories. By using a separate disposable, “Holey fiber” based integral passive hydrostatic feed system for each sample vial, the possibility of contamination of samples is all but eliminated, and the purity of the sample quality is kept pristine. Since a new electrospray needle is used each time, then the possibility of clogging is also eliminated. The preferred embodiment of the invention shows a cross section view of the non-conductive polymer 80 material that will be used to encase the single “Holey fiber” 70. Since the polymer is non-conductive, a means of charging the analyte is needed, for this a metalized plating is coated onto the surface of the disposable, “Holey fiber” based integral passive hydrostatic feed system. As mentioned previously, It is also possible to manufacture the disposable, “Holey fiber” based integral passive hydrostatic feed system out of a conductive polymer, in which case the metalized plating is not needed. The preferred method of the described invention is to use a “sprayed on”, or sputter coat of metal to allow for the liquid analyte in each vial 20 to be placed at a high potential. It is also possible to construct each disposable, “Holey fiber” based integral passive hydrostatic feed system with a separate metal shroud that could be pressed onto the non-conductive rigid housing.

When used with an automated assay system, each separate vial 20 contained in the sample tray 10 would have a unique disposable, “Holey fiber” based integral passive hydrostatic feed system automatically placed inside it. The dimensions are such that a friction fit would hold the two separate pieces together 90. Each individual sample vial 20 contains a different unknown or known analyte solution 30, 40, 50, and 60 that will be tested in a mass spectrometer. When the two individual parts are placed together, a high voltage connection is applied to the metalized portion of the disposable, “Holey fiber” based integral passive hydrostatic feed system, which in turn will allow the liquid analyte to be charged. Upon application of the high voltage, the liquid analyte will be fed into the mass spectrometer through the capillary holes in the “Holey fiber” 70 and undergo the creation of a Taylor cone and subsequent coulomb explosions inside the mass spectrometer. The mechanism of electrospray was discussed previously and will not be revisited. The main point is to express how a complicated and expensive electrospray hydrostatic feed system, connection tubing, and electrospray needle could be replaced with a thumb-sized integral assembly that would eliminate the need for running a cleaning solution through the electrospray needle and hydrostatic feed source each time a new analyte sample is run. Through the use of the described invention, automated mass spectrometric analysis could be made cheaper, faster, and much more efficient than currently possible with traditional mass spectrometers.

Reference Numerals:

FIG. 1:

10 One of several capillary holes running through the length of vascular plant fiber (Xylem) for enabling liquid transport throughout the plant or tree. The plant fiber has been cut perpendicular to the length, and the cut “face” is shown on the top of the Scanning Electron Microscope (SEM) image.

20 Outer surface surrounding structure of plant fiber (Xylem).

FIG. 2:

10 Outer edge of glass optical fiber (Holey fiber) detailing the circular shape (Note: An outer coating usually placed on the glass fiber to protect it (Buffer) has been stripped off to reveal the naked glass core. The diameter of the glass fiber is approximately 225 μm.

20 One of the 168 individual holes that run through the length of the fiber. The hole diameters in this specific SEM image are approximately 4.7 μm. The Holey optical fibers can be made to be any size from about ½ μm to over 30 μm.

30 Cleaved face of glass optical fiber (Holey fiber). The face of the optical fiber is perpendicular to the length of the fiber. The SEM image indicates a geometric arrangement of 168 holes, but for the described invention, a minimum of only one hole will work for transporting minute quantities of liquid.

FIG. 3:

10 Close up view of one of the 168 individual holes that run through the length of the fiber. The SEM image shows the uniformity of the size of the holes.

20 Close up view of the cleaved face of glass optical fiber (Holey fiber). The face of the optical fiber is perpendicular to the length of the fiber.

FIG. 4:

10 Outer protective coating used to cover the glass core to prevent scratching or damage.

20 Glass fiber outer edge. This is the boundary between the protective buffer and the glass fiber.

30 Larger diameter holes that will be used to supply a low vapor pressure oil of viscous liquid to act as a protective coating that will be used to coat a higher vapor pressure liquid to slow its rate of evaporation in a harsh environment, such as that of the vacuum of space.

40 Smaller diameter holes that will be used to supply a high vapor pressure liquid that is intended to be covered with the low vapor pressure oil or liquid so its rate of evaporation in a harsh environment, such as the vacuum of space will be slowed or minimized. The smaller size hole will limit the exposure of the high vapor pressure liquid to the vacuum of space.

50 Detail of the glass fiber core face treated to make it hydrophobic, and thereby preventing the liquid solution from reaching the outer edge of the glass holey fiber. The intent is to confine the two liquids to the center of the glass holey fiber to permit mixing, or coating of the higher vapor pressure liquid. The higher vapor pressure liquid will give a higher thrust for colloidal propulsion applications in space, but will evaporate quickly, due to its higher vapor pressure.

FIG. 5:

10 Three-dimensional drawing of a “Holey fiber” showing the front face, or flat surface of the cleaved end of the “Holey fiber”.

20 Individual capillary holes running through the length of the “Holey fiber”.

30 Surface coated or treated to make it hydrophobic to prevent pooling of liquid from adjacent capillary holes.

40 Main body of “Holey fiber” containing individual capillary holes.

FIG. 6:

10 Three-dimensional drawing of a “Holey fiber” showing the front face, or flat surface of the cleaved end of the “Holey fiber”.

20 Single capillary hole running through the length of the “Holey fiber”.

30 Surface coated or treated to make it hydrophobic to prevent pooling of liquid.

40 Main body of “Holey fiber” containing capillary hole.

FIG. 7:

10 Stainless Steel grounded target that was used to complete the “circuit” to measure the ElectroSpray current.

20 Section of “Holey fiber” that was used to transport and regulate the liquid.

30 Small insulated plastic reservoir used to hold a 50/50 solution of 1-Propanol and distilled water.

40 Wire to connect the positive side of the high voltage DC source to the insulated reservoir of liquid.

50 Wire to connect the return or ground side of the high voltage DC source to the conductive target support.

60 Small section of “Holey fiber” that has a cleaved, perpendicular surface.

FIG. 8:

Graph of the resultant ElectroSpray current versus the applied ElectroSpray voltage for a “Holey fiber” containing 168 capillary holes, each having a diameter of 8.0 um (10⁻⁶ m). The fibers used are a long length of 4.13 inches and a half length of 2.10 inches.

FIG. 9:

10 Main body of capillary sample tube composed of a single capillary fiber (Holey fiber) encased in a firm, rigid support structure.

20 Support structure composed of a rigid transparent polymer or firm, glass, or rigid metal tubing.

30 Small glass fiber (Holey fiber) protruding from the external rigid transparent polymer or firm, rigid metal tubing structural support.

40 Array of capillary holes running through the length of the glass fiber. The number of capillary holes can range from a single capillary hole to a large plurality of individual capillary holes.

50 Surface of material that contains the liquid sample.

60 Liquid droplet containing small amount of material to be collected.

70 Liquid droplet containing small amount of material being collected by the “Holey fiber”.

80 Dashed line indicating original size of liquid droplet before being collected by the “Holey fiber”.

90 Dashed line indicating a separation of the left and right images to detail the pre-collection and collection process.

FIG. 10:

10 Main body of capillary sample tube composed of a single capillary fiber (Holey fiber) encased in a firm, rigid support structure.

20 Non-conductive portion of rigid support structure.

30 Conductive section of rigid support structure created by “spraying on” or sputter coating a layer of metal.

40 Small amount of “Holey fiber” that is protruding from the rigid support structure.

50 Flat surface portion of the “Holey fiber” and rigid support structure that has a perfectly flat, ground surface that will enable a smooth cleaved end of the “Holey fiber” to be realized.

60 Non-conductive portion of rigid support structure.

70 Flat surface portion of the “Holey fiber” and rigid support structure that has a perfectly flat, ground surface that will enable a smooth cleaved end of the “Holey fiber” to be realized.

80 Conductive section of rigid support structure created by “spraying on” or sputter coating a layer of metal.

90 Small amount of “Holey fiber” that is protruding from the rigid support structure.

100 Cross-section indicating that there is a uniform, homogenous polymer structure throughout the interior of the sampler assembly.

110 Dashed line indicating a separation of the left and right images to detail a fully assembled drawing and a cut-away sectional view to detail the interior structure.

FIG. 11:

10 Assay sample tray that will be used to hold the individual liquid analyte sample vials for automated testing.

20 Individual liquid analyte sample vials that will contain samples.

30 Small Liquid analyte sample composed of either a known or unknown substance.

40 Small Liquid analyte sample composed of either a known or unknown substance.

50 Small Liquid analyte sample composed of either a known or unknown substance.

60 Small Liquid analyte sample composed of either a known or unknown substance.

70 Inner section of rigid support structure showing the “Holey fiber”.

80 Main body of integral sample assembly containing the “Holey fiber”.

90 Dashed line indicating the insertion of an integral sample assembly containing the “Holey fiber” into a liquid analyte sample vial.

1. a method of utilizing glass optical fibers containing small diameter holes running through the length of the glass fiber to provide for a passive and self regulated liquid feed system

2. a method as in claim 1 where the diameter of the holes are all of uniform size diameters

3. a method as in claim 1 where the diameter of the holes are of varying size diameters
